(19) United States
(12) Patent Application Publication
(10) Pub. No.: US 2007/0194610 A1
(43) Pub. Date: Aug. 23, 2007

(54) Seat assembly

(76) Inventor: Daniel Lee, Nantou City (TW)

Correspondence Address: MCNEES WALLACE & NURICK LLC, 100 PINE STREET, P.O. BOX 1166, HARRISBURG, PA, 17108-1166, US

(21) Appl. No.: 11/358,451

(22) Filed: Feb. 21, 2006

(51) Int. Cl. B62J 1/00

(52) U.S. Cl. 297/195.1; 297/214

(57) ABSTRACT

A seat assembly includes a seat body having a front end and a rear end opposite to the front end, a front protecting member coupled to the front end of the seat body and protruding there from, and a rear protecting member coupled to the rear end of the seat body and protruding therefrom. Each of the front and rear protecting members has a soft cover and a rigid core body enclosed by the soft cover.

### BACKGROUND OF THE INVENTION

1. Field of the Invention

This invention relates to a seat assembly, more particularly to a seat assembly including a seat body provided with at least one protecting member having a rigid core body covered by a soft cover.

2. Description of the Related Art

A bicycle is relatively lightweight and tends to tip due to an external force. When the bicycle tips, its seat normally impacts a wall or the ground. The seat generally has a leather skin layer bearing a decorative pattern. When the bicycle tips, the leather skin layer will be damaged or scratched due to sudden impact with the wall or the ground.

In order to alleviate the problem mentioned above, referring to FIG. 1, an improved seat assembly 10 has been proposed. The seat assembly 10 includes a seat body 11, a supporting frame 12 disposed beneath and fixed to the seat body 11, and a front bumper 13 and a rear bumper 14 coupled to the front end and the rear end of the seat body 11, respectively. The seat body 11 includes a rigid base 111, a decorative skin layer 113 connected to the rigid base 111 so as to define a space therebetween, and a foam layer 112 filled in the space.

Generally, the front bumper 13 and the rear bumper 14 of the seat assembly 10 are both made from a rigid plastic material, such as polypropylene. Each of the front bumper 13 and the rear bumper 14 has an ear portion 131, 141 extending toward and fastened to the rigid base 111. Each of the front bumper 13 and the rear bumper 14 further includes a protective portion 132, 142 opposite to the ear portion 131, 141. The protective portions 132, 142 of the front bumper 13 and the rear bumper 14 extend outwardly from the seat body 11 and have impact surfaces, respectively when the bicycle tips (not shown), the impact surfaces of the front bumper 13 and the rear bumper 14 will impact the wall or the ground earlier than the decorative skin layer 113 so as to reduce chances of contact between the decorative skin layer 113 and the wall or the ground, thereby preventing the decorative skin layer 113 from being damaged or scratched.

As mentioned above, the front bumper 13 and the rear bumper 14 are generally made from rigid plastic material so as to endure undesired impact with the wall or the ground. However, scratches and rough surfaces are easily formed on the front bumper 13 and the rear bumper 14 made from the rigid plastic material when the bicycle impacts the wall or the ground, thereby resulting in unappealing appearance and uncomfortable feel of the front bumper 13 and the rear bumper 14.

### SUMMARY OF THE INVENTION

Therefore, the object of the present invention is to provide a seat assembly that can alleviate at least one of the aforesaid drawbacks of the prior art.

According to this invention, a seat assembly includes a seat body having a front end and a rear end opposite to the front end, a front protecting member coupled to the front end of the seat body and protruding therefrom, and a rear protecting member coupled to the rear end of the seat body and protruding therefrom. Each of the front and rear protecting members has a soft cover and a rigid core body enclosed by the soft cover.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic sectional view to illustrate a conventional seat assembly;

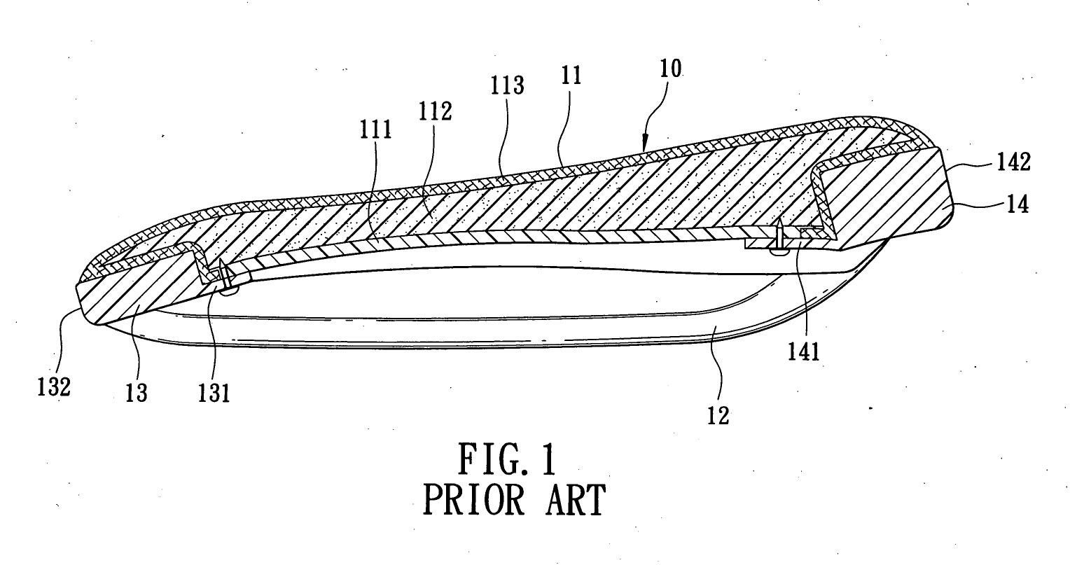

FIG. 2 is a perspective view to illustrate the preferred embodiment of a seat assembly according to this invention;

FIG. 3 is an exploded fragmentary perspective view of the preferred embodiment of FIG. 2; and

FIG. 4 is a schematic sectional view of the preferred embodiment of FIG. 2.

### DETAILED DESCRIPTION OF THE PREFERRED EMBODIMENT

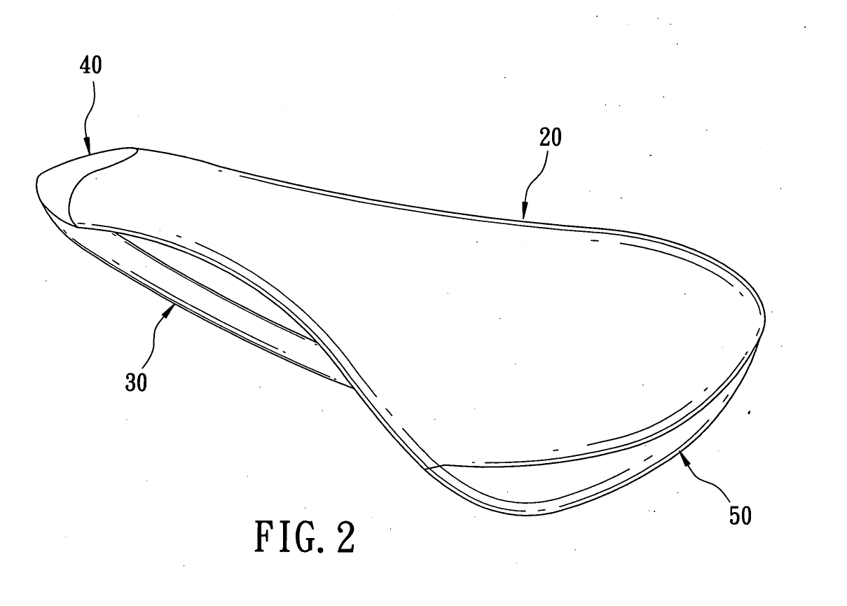

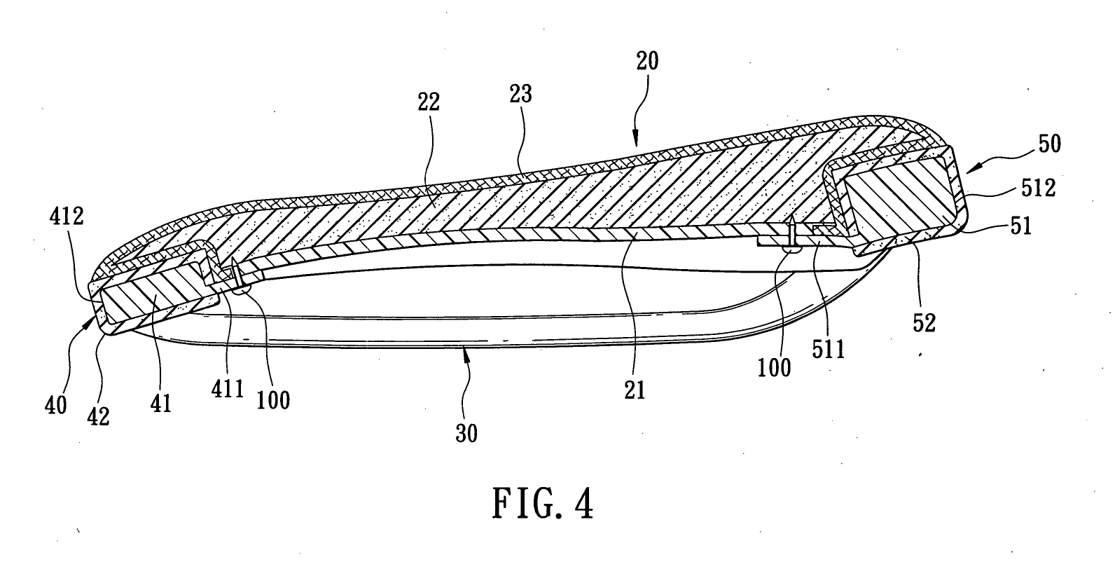

Referring to FIGS. 2 and 4, the preferred embodiment of a seat assembly according to this invention includes: a seat body 20 having a front end and a rear end opposite to the front end; a front protecting member 40 coupled to the front end of the seat body 20 and protruding therefrom; and a rear protecting member 50 coupled to the rear end of the seat body 20 and protruding therefrom. Each of the front and rear protecting members 40, 50 has a soft cover 42, 52 and a rigid core body 41, 51 enclosed by the soft cover 42, 52.

A non-limiting example of the seat body 20 has a top surface, and a bottom surface opposite to the top surface, and includes a skin layer 23 defining the top surface of the seat body 20, a rigid base 21 defining the bottom surface of the seat body 20 and connected to the skin layer 23 to define an enclosed space therebetween, and a foam layer 22 filled in the enclosed space between the skin layer 23 and the rigid base 21. The seat assembly further includes a supporting frame 30 disposed beneath and fixed to the rigid base 21 of the seat body 20.

Preferably, the rigid core body 41, 51 of each of the front and rear protecting members 40, 50 is made from a rigid plastic material. More preferably, the rigid plastic material is composed of polypropylene.

Preferably, the soft cover 42, 52 of each of the front and rear protecting members 40, 50 is made from thermoplastic resins.

In a non-limiting example of the front and rear protecting members 40, 50, the soft cover 42, 52 and the rigid core body 41, 51 of each of the front and rear protecting members 40, 50 are integrally molded.

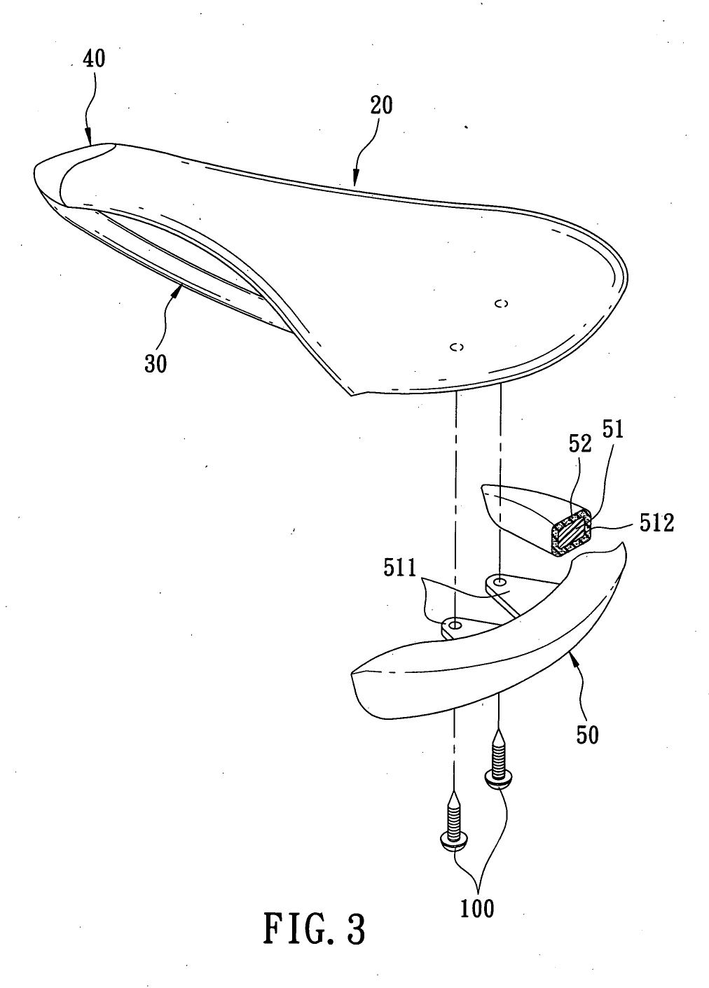

With further reference to FIG. 3, each of the front and rear protecting members 40, 50 has at least one flange 411, 511 extending from the rigid core body 41, 51 toward the seat body 20, and is fastened to a respective one of the front and rear ends of the seat body 20. In a non-limiting example, each of the front and rear protecting members 40, 50 is fastened to the respective one of the front and rear ends of the seat body 20 with the use of screws 100.

According to this invention, since each of the front and rear protecting members 40, 50 has a soft cover 42, 52 and a rigid core body 41, 51 enclosed by the soft cover 42, 52, the soft covers 42, 52 of the front and rear protecting members 40, 50 can serve as impact surfaces 412, 512. When a bicycle (not shown) including the seat assembly of this invention tips such that the seat assembly impacts a wall or the ground, the impact surfaces 412, 512 of the soft covers 42, 52 of the front and rear protecting members 40, 50 are capable of protecting the rigid core bodies 41, 51 from being scratched or damaged. Consequently, the seat assembly can keep an appealing appearance and a smooth touch.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A seat assembly, comprising:
a seat body having a front end and a rear end opposite to said front end;
a front protecting member coupled to said front end of said seat body and protruding therefrom; and
a rear protecting member coupled to said rear end of said seat body and protruding therefrom;
wherein each of said front and rear protecting members has a soft cover and a rigid core body enclosed by said soft cover.

2. The seat assembly of claim 1, wherein said rigid core body of each of said front and rear protecting members is made from a rigid plastic material.

3. The seat assembly of claim 2, wherein said rigid plastic material is composed of polypropylene.

4. The seat assembly of claim 1, wherein said soft cover of each of said front and rear protecting members is made from thermoplastic resins.

5. The seat assembly of claim 1, wherein said soft cover and said rigid core body of each of said front and rear protecting members are integrally molded.

6. The seat assembly of claim 1, wherein said seat body has a top surface, a bottom surface opposite to said top surface, and includes a skin layer defining said top surface of said seat body, a rigid base defining said bottom surface of said seat body and connected to said skin layer to define an enclosed space therebetween, and a foam layer filled in said enclosed space between said skin layer and said rigid base, said seat assembly further comprising a supporting frame disposed beneath and fixed to said rigid base of said seat body.

7. The seat assembly of claim 1, wherein each of said front and rear protecting members has a flange extending from said rigid core body toward said seat body, and is fastened to a respective one of said front and rear ends of said seat body.
